(19) United States
(12) Patent Application Publication
(10) Pub. No.: US 2026/0356297 A1
(43) Pub. Date: Nov. 12, 2026

(54) VEHICLE, RACK, AND BRACKET

(71) Applicants: KAWASAKI MOTORS, LTD., Akashi-shi (JP); SOUCY INTERNATIONAL INC., Quebec (CA)

(72) Inventors: Justin OLSON, Lincoln, NE (US); Brian BUTLER, Lincoln, NE (US); John RAMEY, Lincoln, NE (US); Frederik BESSETTE, Quebec (CA); Philippe JAILLET-GOSSELIN, Quebec (CA); Anthony MORIN, Quebec (CA); Vincent MORIN, Quebec (CA); Gabriel BOISVERT, Quebec (CA); Laurent BLAIR, Quebec (CA); Jean-Francois PICARD, Quebec (CA)

(73) Assignees: KAWASAKI MOTORS, LTD., Akashi-shi (JP); SOUCY INTERNATIONAL INC., Quebec (CA)

(21) Appl. No.: 19/439,516

(22) Filed: Jan. 5, 2026

Related U.S. Application Data
(60) Provisional application No. 63/743,325, filed on Jan. 9, 2025.

(51) Int. Cl. B60R 9/06

(52) U.S. Cl. CPC B60R 9/06

(57) ABSTRACT

A vehicle includes a vehicle main body and at least one rear pillar extending upward with respect to the vehicle main body. The rear pillar includes at least one mounting portion to which at least one additional component such as a cargo carrier is detachably mountable.

### CROSS-REFERENCE TO RELATED APPLICATION

The present application claims priority to U.S. Provisional Application No. 63/743,325, filed on Jan. 9, 2025, the content of which is incorporated herein by reference.

### TECHNICAL FIELD

This disclosure relates to a technology for equipping a vehicle with an additional component.

### BACKGROUND ART

US2015/0014378A1 discloses a golf cart including a golf bag hoop.

U.S. Pat. No. 11,155,215B1 discloses a device for carrying a golf club bag, an ice chest, a portable air conditioning unit, and other loads.

### SUMMARY

A vehicle includes: a vehicle main body; and at least one rear pillar extending upward with respect to the vehicle main body, the rear pillar including at least one mounting portion to which at least one additional component is detachably mountable.

This vehicle facilitates mounting the additional component on the vehicle, using the mounting portion of the rear pillar.

Furthermore, a rack is a rack mountable to a vehicle, the rack including: a base mountable to the vehicle; and a variable arm supported by the base variably between first and second positions.

In this rack, the variable arm can be changed between the first and second positions. Changing the position of the variable arm can dispose an object at a position at which the object is easily supported or the variable arm hardly protrudes.

This bracket includes: a vehicle fixing portion; an additional-component fixing portion; and a coupling portion supporting the vehicle fixing portion and the additional-component fixing portion with space, wherein the additional-component fixing portion includes an additional-component fixing hole for fixing an additional component.

Since the fixing portion is spaced from the additional-component fixing portion in this bracket, the additional component can be easily fixed using a clamp and the additional-component fixing hole.

The objects, features, aspects, and advantages of this disclosure will become more apparent from the following detailed description and the accompanying drawings.

### BRIEF DESCRIPTION OF DRAWINGS

FIG. 1 is a side view illustrating a vehicle.

FIG. 2 is a side view illustrating the vehicle in another state.

FIG. 3 is a perspective view of the vehicle when viewed from the rear.

FIG. 4 is an explanatory diagram illustrating a bracket mounted on a pillar main body.

FIG. 5 is a perspective view illustrating the bracket.

FIG. 6 is a perspective view illustrating a mounting portion of a rack.

FIG. 7 is a perspective view illustrating the mounting portion of the rack when viewed from the inside in a vehicle-width direction.

FIG. 8 is a perspective view illustrating a state in which a partition is mounted on an upper bracket.

FIG. 9 is a side view illustrating a state in which the partition is mounted on a lower bracket.

FIG. 10 is a perspective view illustrating a modification of a positioning portion.

FIG. 11 is a plan view illustrating a lower rack.

### DESCRIPTION OF THE PREFERRED EMBODIMENTS

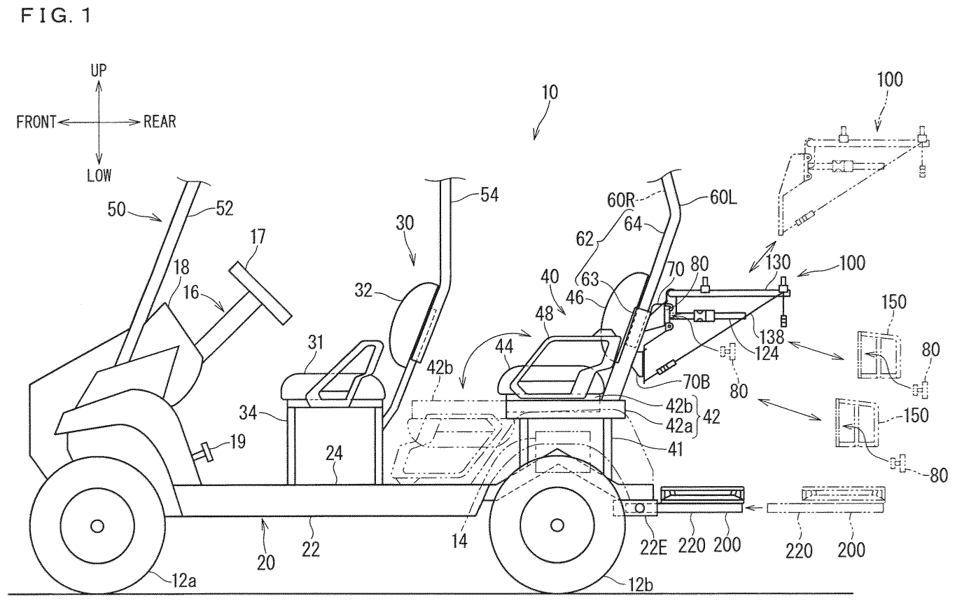

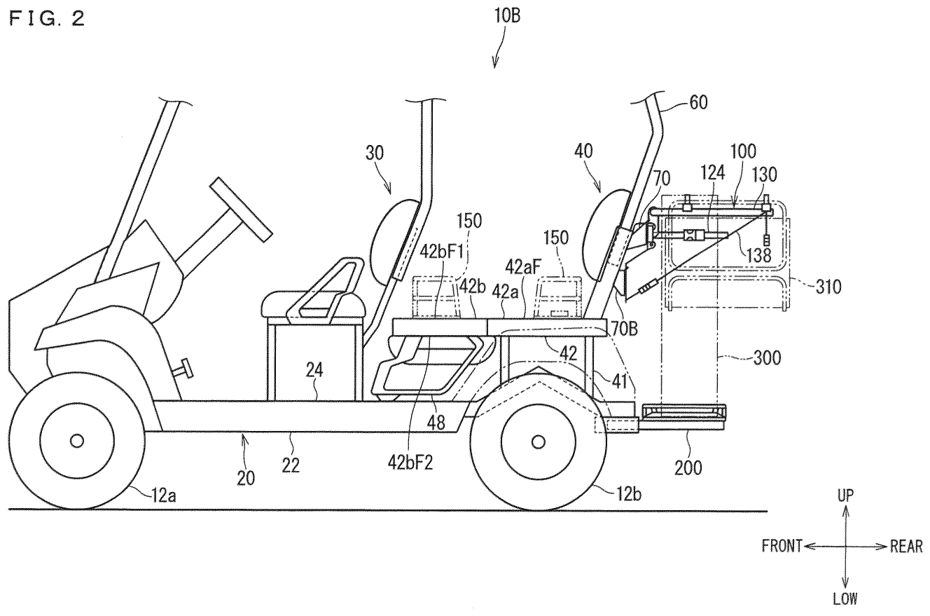

A vehicle, a rack, and a bracket according to an embodiment will be hereinafter described. FIGS. 1 and 2 are side views illustrating a vehicle 10. In FIGS. 1 and 2, the vehicle 10 is equipped with a rack 100 as an additional component. The vehicle 10 may be equipped with partitions 150 as additional components, instead of the rack 100. The vehicle 10 may be equipped with a lower rack 200. In FIG. 2, a load 310 and a load 300 are placed on the rack 100 and the lower rack 200, respectively.

In the following description, traveling directions of the vehicle 10 may be expressed as forward, backward opposite to the forward direction, downward toward a driving surface, and upward opposite to the downward direction. Examples of the driving surface include the ground and roads. Furthermore, the right and left may be referred to while a person stands on a driving surface and faces forward. A lateral direction is a vehicle-width direction.

The vehicle 10 is a vehicle that travels on a driving surface. The vehicle 10 may be, for example, an off-road vehicle. The off-road vehicle may be a versatile small vehicle suitable for off-road travel rather than traveling through public roads at high speeds.

Examples of the off-road vehicle include a side-by-side vehicle. The side-by-side vehicle is, for example, a small vehicle suitable for all terrain travel, and a vehicle in which occupants can be seated side by side. The side-by-side vehicle may be, for example, a multipurpose off-highway utility vehicle (MOHUV) defined by ANSI/OPEI B71.9-2016, and a recreational off-highway vehicle defined by ANSI/ROHVA 1-2016.

The vehicle 10 may be a passenger transport vehicle designed to travel at low speeds within a limited area.

Examples of the limited area may include limited community areas, private roads, and private lands (e.g., golf courses and parks). The limited community areas are areas provided for use by community residents. The community areas are, for example, areas including houses and public facilities (e.g., schools and hospitals), and are areas in which vehicles designed to travel through non-public highways are permitted to travel at low speeds. The low speeds are, for example, speeds with upper limits ranging from 20 mph to 30 mph. Examples of the vehicle 10 include personal transport vehicles (PTVs) in accordance with ANSI/ILTVA Z135, and golf carts in accordance with ANSI/ILTVA Z130.1. The examples of the vehicle 10 include personal transportation electric vehicles.

The vehicle 10 may be a vehicle in which at least two occupants can ride side by side. The vehicle 10 may be opened outside of seats 30 and 40 in a vehicle-width direction without being obstructed by walls or doors to facilitate the occupant getting on or off the vehicle 10. Here, the occupant can walk past in the lateral direction without being obstructed by doors or walls.

The vehicle 10 includes a vehicle body 20, wheels 12a and 12b, a travel driving device 14, and a steering device 16.

The vehicle body 20 functions as a support structure for supporting the units of the vehicle 10. The vehicle body 20 includes, for example, a vehicle main body 22 and pillars 50.

The vehicle main body 22 includes a floor 24. The floor 24 is located at the bottom of the riding space for occupants. The floor 24 is a portion including a surface which supports the feet of the occupant during a ride and on which the feet of the occupant are placed for movement when the occupant gets on or off the vehicle. The floor 24 is a plate-shaped portion expanding in the horizontal direction. The floor 24 may be a floor board, or a combined portion of a vehicle frame and a floor board. The vehicle body may have a monocoque structure.

The wheels 12a and 12b are rotatably supported by the vehicle main body 22. The wheels 12a and 12b may be supported by the vehicle main body 22 through a suspension system. The wheels 12a and 12b may include two front wheels 12a and two rear wheels 12b. For example, the two front wheels 12a are rotatably supported by right and left front portions of the floor 24. The number of the front wheels 12a may be one. For example, the two rear wheels 12b are rotatably supported by right and left rear portions of the floor 24.

The travel driving device 14 is a device for making the vehicle 10 travel. The travel driving device 14 is supported by the vehicle main body 22. The travel driving device 14 includes, for example, a motor. The motor may be an electric motor or an internal combustion engine. For example, a rotation shaft of the motor is coupled to a shaft of the rear wheels 12b directly or through gears. Transmission of rotation drive force of the motor to the rear wheels 12b allows the vehicle 10 to travel. The motor may be located, for example, between the two rear wheels 12b.

The steering device 16 is a device for controlling a driving operation of the vehicle 10. Examples of the driving operation include driving, a stop, a speed, and a traveling direction of the vehicle 10.

The steering device 16 includes, for example, a steering wheel 17 located behind the front wheels 12a. The steering wheel 17 is rotatably supported by a steering shaft. The steering wheel 17 is located closer to the front on the floor 24. The steering wheel 17 is located in front of the first seat 30. The steering shaft is coupled to the front wheels 12a through, for example, a steering gear. The front wheels 12a are rotated around a steering axis through operations of the steering wheel 17. Rotation of the front wheels 12a around the steering axis changes a traveling direction of the vehicle 10.

An instrument panel 18 that displays, for example, a speedometer and the remaining battery power may be installed in front of the steering wheel 17. An operation pedal 19 may be installed at a position below the steering wheel 17. The operation pedal 19 may be, for example, one pedal that can control a start, an acceleration, a deceleration, and a stop by adjusting a degree of stepping on the pedal. The operation pedal 19 may be a set of a brake pedal and an accelerator pedal.

The vehicle 10 may be a remote controlled vehicle or an autonomous driving vehicle. In such a case, the steering wheel 17 and the operation pedal 19 may be omitted.

The vehicle 10 includes the first seat 30 and the second seat 40. The floor 24 is located below the first seat 30 and the second seat 40.

The floor 24 supports the first seat 30. The first seat 30 is located above the floor 24 and behind the instrument panel 18. The first seat 30 is located in front of the second seat 40. The first seat 30 includes a driver seat. The driver seat is located behind the steering wheel 17. The driver is seated on the driver seat, and can operate the steering wheel 17 and the operation pedal 19.

The first seat 30 may include a seat on which another occupant can be seated next to the driver. The first seat 30 may have a width with which two occupants including the driver can be seated side by side.

The first seat 30 includes, for example, a seat portion 31 and a back rest portion 32. The first seat 30 is supported on the floor 24 by, for example, a seat support frame 34 protruding upward from the floor 24. The seat surface of the seat portion 31 faces upward. The back rest portion 32 is located above and behind the seat portion 31. The back rest portion 32 supports the back of the occupant to be seated on the seat portion 31 from behind.

The second seat 40 is located behind and away from the first seat 30. The second seat 40 includes a seat base 42, a seat portion 44, and a back rest portion 46.

The seat base 42 is supported at a position above the floor 24 by, for example, a seat support frame 41 mounted upright on a portion between the two rear wheels 12b in the vehicle body 20. The seat portion 44 is supported on the seat base 42. The seat surface of the seat portion 44 faces upward. The seat portion 44 may be elongated in the lateral direction such that persons can be seated.

The back rest portion 46 is located above and behind the seat portion 44. The back rest portion 46 is oriented obliquely upward from a rear portion of the seat portion. The back rest portion 46 supports the back of the occupant to be seated on the seat portion 44 from behind. The second seat 40 may include armrests 48 for the occupant seated on the second seat 40 to rest the elbows.

The second seat 40 may be changeable between a seating state and a load-carrying state. The seating state is a state in which the occupant can be seated. The load-carrying state is a state in which a load can be placed.

FIG. 1 illustrates the second seat 40 in the seating state, using solid lines. The second seat 40 in the load-carrying state is illustrated, using two-dot chain lines in FIG. 1 and using solid lines in FIG. 2.

Specifically, the seat base 42 includes a main base 42a and an extension base 42b.

The main base 42a is formed into a flat shape expanding in the horizontal direction. The main base 42a may be elongated in the lateral direction such that the whole seat portion 44 in a width direction can be supported from the bottom. The main base 42a is supported, for example, by the seat support frame 41 at a position above the floor 24. A surface of the main base 42a which faces upward is a mounting surface 42aF on which a load is to be placed.

A lateral width of the main base 42a may be set as large as or larger than that of the seat portion 44. A front-to-rear length of the main base 42a may be set identical to or larger than that of the seat portion 44. In this embodiment, the front-to-rear length of the main base 42a is set larger than that of the seat portion 44. In a plan view, the front portion of the seat portion 44 is disposed along the front edge of the main base 42a, and the rear portion of the main base 42a extends rearward of the seat portion 44.

The extension base 42b is formed into a flat shape. The extension base 42b may be elongated in the width direction such that the bottom of the seat portion 44 can be supported.

One main surface of the extension base 42b is a load mounting surface 42bF1 on which a load is to be placed. The other main surface of the extension base 42b is a seat mounting surface 42bF2 on which the seat portion 44 is disposed. The load mounting surface 42bF1 and the seat mounting surface 42bF2 are opposing surfaces.

A lateral width of the extension base 42b may be set as large as or larger or smaller than that of the main base 42a.

A front-to-rear length of the extension base 42b may be set identical to or larger or smaller than that of the main base 42a. In this embodiment, the front-to-rear length of the extension base 42b is set smaller than that of the main base 42a. In a plan view, the whole length of the extension base 42b in the forward and backward direction can be disposed within the main base 42a.

The extension base 42b is movably supported between a deployed position and a folded position.

As illustrated in FIG. 2, the deployed position is a position at which the extension base 42b is deployed from the main base 42a. As illustrated in FIG. 1, the folded position is a position at which the extension base 42b is folded into the main base 42a.

In a plan view, the folded extension base 42b overlaps the main base 42a. In this embodiment, the whole folded extension base 42b overlaps the main base 42a. In this state, the rear end of the main base 42a extends rearward of the extension base 42b.

In a plan view, the deployed extension base 42b extends into a region different from that of the main base 42a. In this embodiment, the whole deployed extension base 42b extends into the region different from that of the main base 42a. At least a part of the deployed extension base 42b should extend or expand into the region different from that of the main base.

In this embodiment, the extension base 42b is coupled to the front edge of the main base 42a through a hinge.

In a state where the extension base 42b is disposed at the folded position, the seat mounting surface 42bF2 of the extension base 42b which is opposite to the main base 42a faces upward. The seat portion 44 is fixed on the seat mounting surface 42bF2 by, for example, screwing. Thus, the seat portion 44 is located on the seat base 42. The occupant can be seated on the seat portion 44.

In a state where the extension base 42b is disposed at the deployed position, the extension base 42b extends frontward of the main base 42a. In this state, the load mounting surface 42bF1 of the extension base 42b may be disposed at the same height position as that of the mounting surface 42aF of the main base 42a. However, there may be a step height between the load mounting surface 42bF1 and the mounting surface 42aF.

Furthermore, the seat mounting surface 42bF2 faces downward in this state. The seat portion 44 is located below the seat mounting surface 42bF2, and is located between the main base 42a and the first seat 30.

The armrests 48 are fixed to the extension base 42b and both sides of the seat portion 44 by, for example, screwing. In the state where the extension base 42b is disposed at the folded position, the armrests 48 protrude upward from the extension base 42b and both sides of the seat portion 44. In the state where the extension base 42b is disposed at the deployed position, the armrests 48 protrude downward from the extension base 42b and both sides of the seat portion 44. In this state, portions of the armrests 48 that are the farthest from the seat surface of the seat portion 44 are disposed on the floor 24. This allows the armrests 48 to support the extension base 42b at a fixed height position above the floor 24.

The mounting surface 42bF1 faces upward in the state where the extension base 42b is disposed at the deployed position. A load can be placed on the mounting surface 42bF1 facing upward. Thus, the extension base 42b may be understood as an example carrier. The extension base 42b in a deployed state and the main base 42a may be understood as an example carrier.

The partitions 150 may be detachably mounted on the main base 42a. The partitions 150 may be detachably mounted on the extension base 42b. The partitions 150 are components that partition a space above the main base 42a or the extension base 42b. The partitions 150 may, for example, enclose an object on the main base 42a or the extension base 42b to prevent the object from falling from the base 42a or 42b.

The pillars 50 are parts of the vehicle body 20. The pillars 50 extend upward with respect to the vehicle main body 22. The pillars 50 extend upward, for example, from the floor 24 or the frames supported by the floor 24.

The pillars 50 include front pillars 52, center pillars 54, and rear pillars 60.

The front pillars 52 include right and left front pillars 52. The right and left front pillars 52 extend upward from right and left front portions in front of the first seat 30 in the vehicle body 20. The front pillars 52 may be referred to as A-pillars. The front pillars 52 may support a windshield in front of the first seat 30.

The center pillars 54 include right and left center pillars 54. The right and left center pillars 54 extend upward from right and left portions of the back rest portion 32 of the first seat 30. The center pillars 54 may be referred to as B-pillars.

The rear pillars 60 include right and left rear pillars 60. The right and left rear pillars 60 are directed from below to above, at positions behind the back rest portion 46 of the second seat 40. The lower ends of the right and left rear pillars 60 are fixed to right and left portions of the seat support frame 41. The lower ends of the right and left rear pillars 60 may be fixed to the floor 24 or frames extending from the floor 24.

The rear pillars 60 may be referred to as C-pillars. The rear pillars 60 may be rearmost pillars of the pillars located at portions in the forward and backward direction. The rear pillars 60 may be pillars behind a rearmost seat.

The right and left rear pillars 60 extend upward with respect to the vehicle main body 22. The right and left rear pillars 60 extend in an upward and downward direction behind the seat portion 44. The back rest portion 46 of the second seat 40 may be fixed to the right and left rear pillars 60 at a position behind and above the seat portion 44. The seat portion 44 can be moved while the back rest portion 46 remains at a fixed position. The back rest portion may be supported at a fixed position by other frames except the rear pillars.

The vehicle 10 may include a top component. The top component is a component above the first seat 30 and the second seat 40.

The top component may be, for example, a top frame extending in the forward and backward direction. The top frame may extend to couple the upper ends of the pillars 52, 54, and 60 at respective right and left positions. The top frame may include a frame extending in the lateral direction.

The top component may be a roof. The roof may be supported by the pillars 52, 54, and 60 to cover the first seat 30 and the second seat 40 from the top.

The number of the pillars 52, 54, and 60 is discretionary. For example, the center pillars 54 may be omitted.

The vehicle 10 does not include a body covering both sides of the vehicle body 20. As described above, the pillars 52, 54, and 60 are not located at both outside portions of the space between the first seat 30 and the second seat 40 in the vehicle-width direction. Thus, passenger entrances are permanently open at both outside portions of the space between the first seat 30 and the second seat 40 in the vehicle-width direction. Consequently, an occupant getting on or off the second seat 40 can get on from one of the right and left passenger entrances, walk past through the space between the first seat 30 and the second seat 40, and get off from the other passenger entrance.

The permanently open passenger entrances refer to passenger entrances that are open without being obstructed by doors or walls that block the occupant getting on or off the vehicle. Thus, the passenger entrances may be covered with, for example, a flexible sheet for a weather shield.

The rear pillars 60 include mounting portions. Each of the mounting portions is a mounting portion to which an additional component is detachably mountable. Examples of the mounting portions include a bracket 70.

The additional component is, for example, a component to be added to a vehicle already shipped from a factory or a vehicle already provided to the user. It is possible for the additional component to be mounted to the vehicle at the factory, if desired, or shipped to a retailer or end user at a later time.

Examples of the additional component include the rack 100 and the partitions 150. The rack 100 or the partitions 150 are detachably mounted on the brackets 70. The rack 100 and/or the partitions 150 are examples of a cargo carrier. This allows the rack 100 or the partitions 150 to be detachably supported by the rear pillars 60.

In other words, this embodiment discloses the vehicle 10 including the mounting portions without any additional component, and a vehicle 10B with the rear pillars 60 on which additional components are mounted through the mounting portions.

The lower rack 200 may be detachably supported in the vehicle 10.

For example, the lower rack 200 is supported at the rear of the floor 24. The rack 100 is supported at the rear of the rear pillars 60. The rack 100 is located above the lower rack 200.

The load 300 is placed on the lower rack 200. The load 300 is disposed at the same height position as the rack 100 or has a height exceeding the rack 100 upwardly. The rack 100 supports the middle portion or the upper end of the load 300 in the upward and downward direction, so that the load 300 on the lower rack 200 may be supported to keep the load 300 from falling over. The load 300 is, for example, a golf bag.

The rack 100 may support the load 310. For example, the rack 100 may include variable arms 130 (also referred to as movable arms 130), and the variable arms 130 may support the load 310. The load 310 carried or supported by any rack, arms, partition, or cargo carrier may be, for example, any desired type of load including, for example, a folding chair, a bicycle, groceries, pool noodles, or building supplies, or any other load.

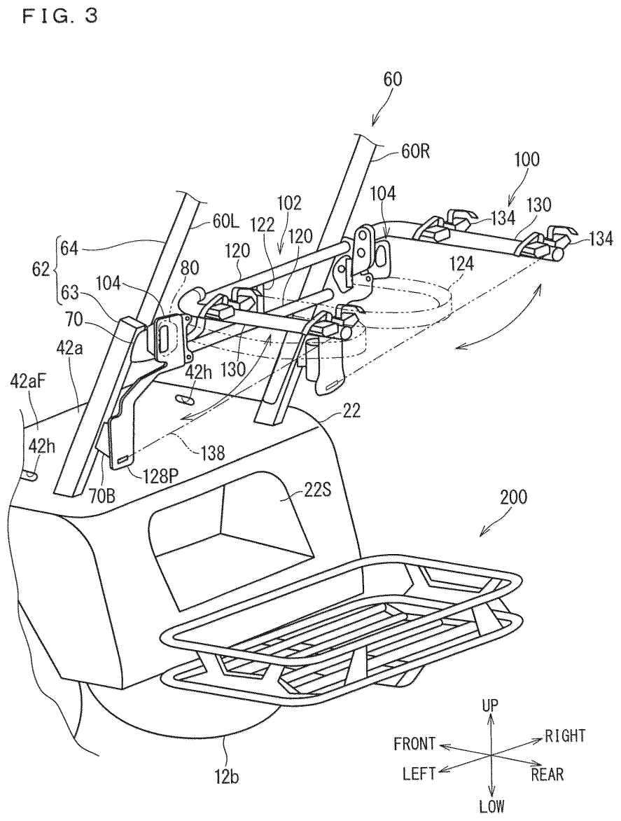

The rear pillars 60 will be described. FIG. 3 is a perspective view of the vehicle 10 when viewed from the rear.

As illustrated in FIGS. 1 to 3, the mounting portions of the rear pillars 60 have a structure suitable for mounting additional components.

The mounting portions may have, for example, holes as the structure suitable for mounting additional components. The holes may be holes for screwing. The holes for screwing may be, for example, holes through which screws pass or holes to be threadably engaged with screws. The holes to be threadably engaged with screws may or need not extend therethrough. The holes may include a hole for fixing using a clamp. The clamp is, for example, a component that passes through a hole and also fix an additional component to a mounting portion by sandwiching a mounting target component from both sides in a direction of passing through the hole.

The holes may include an additional-component fixing hole penetrating in a direction crossing the longitudinal direction of the rear pillar 60. Here, inserting a screw or a clamp into the additional-component fixing hole in the direction crossing the longitudinal direction of the rear pillar 60 facilitates fixing an additional component to the rear pillar 60. Here, the hole may penetrate in the forward and backward direction.

The structure suitable for mounting the additional components may be a structure with screws. The screws may be parts integrated with the rear pillars 60, for example, by welding or screwing.

The mounting portions may face rearward of the vehicle main body 22. The mounting portions facing rearward may mean that, for example, openings of the holes face rearward or a direction in which screws protrude is a rear direction.

This embodiment will describe an example in which a mounting portion is the bracket 70.

Each of the rear pillars 60 includes, for example, a pillar main body 62 and the bracket 70. The pillar main body 62 is a rod extending upward with respect to the vehicle main body 22.

The bracket 70 is mounted on this pillar main body 62. The bracket 70 may be detachably mounted on the pillar main body 62. For example, the bracket may be detachably mounted on the pillar main body by screwing or a clamp. The bracket may be non-detachably mounted on the pillar main body. For example, the bracket may be mounted on the pillar main body by welding.

Not only the screws, fixing through a clamp, and fixing through welding but also an engaging structure may be available in a mounting portion of a bracket onto the pillar main body.

In this embodiment, the pillar main body 62 includes a square tube 63 and a round tube 64.

The square tube 63 is a rectangular tube and extends upward from a lower portion of the seat portion 44. A lower end of the square tube 63 may be a lower end of the pillar main body 62, and may be fixed to the seat support frame 41, the floor 24, or a frame extending from the floor 24.

The round tube 64 is a circular tube. The round tube 64 is fixed to the square tube 63, and extends upward further from the square tube 63. The round tube 64 may be fixed to the square tube 63 by screwing or welding.

The square tube 63 is inclined rearward as progressing upward. The round tube 64 extends along an extension of the square tube 63. The pillar main body 62 consists of the square tube 63, and a portion of the round tube 64 extending along the extension of the square tube 63. Thus, the pillar main body 62 is an elongated portion that is inclined rearward as progressing upward.

An upwardly extending portion of the pillar main body 62 need not be inclined rearward as progressing upward.

The bracket 70 is mounted on the pillar main body 62. For example, the bracket 70 is mounted on a portion of the square tube 63 which faces rearward.

This embodiment will describe an example in which each of the rear pillars 60 includes the pillar main body 62 and the bracket 70, the bracket 70 is a mounting portion, and an additional component is detachably mounted on the bracket 70.

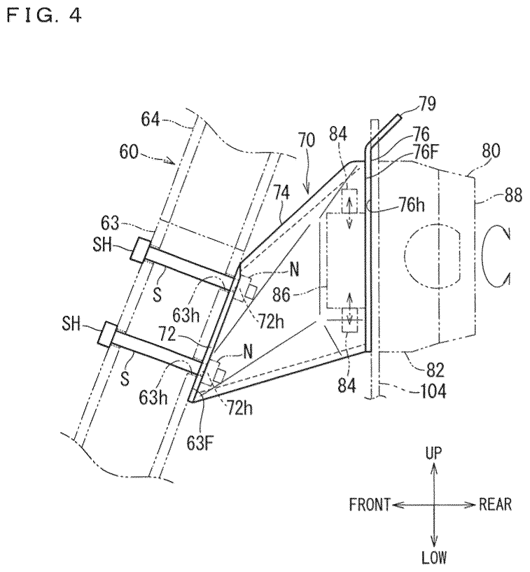

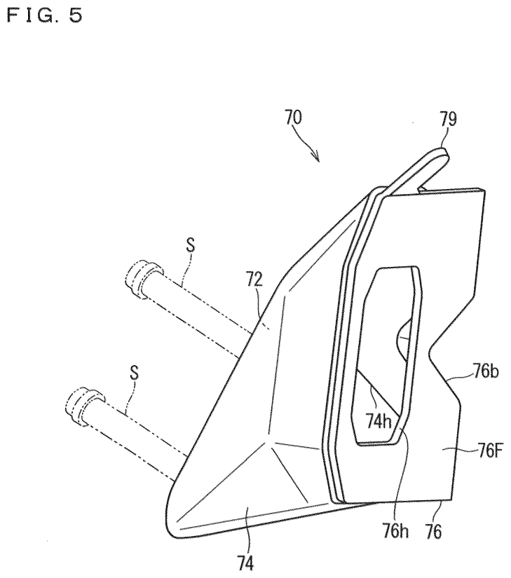

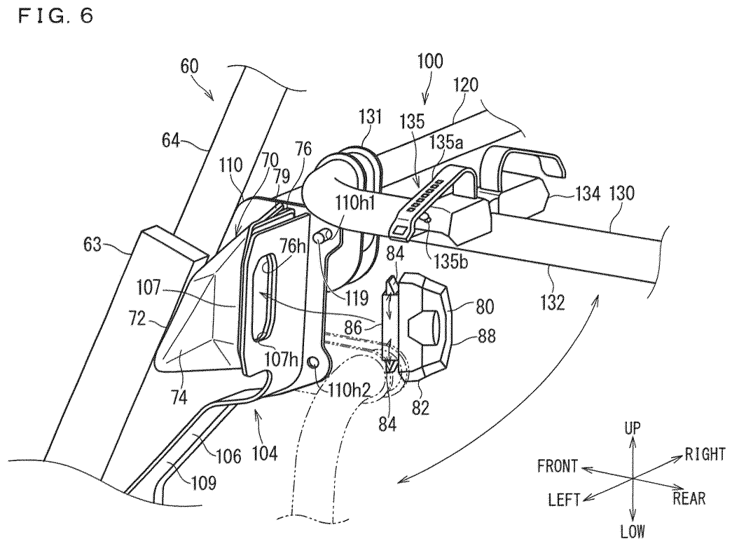

An example of the bracket 70 will be specifically described. FIG. 4 is an explanatory diagram illustrating the bracket 70 mounted on the pillar main body 62. FIG. 4 illustrates the square tube 63, the clamp 80, and a mounting base 104 that is a part of the rack 100, using two-dot chain lines. FIG. 5 is a perspective view illustrating the bracket 70. FIG. 6 is a perspective view illustrating a mounting portion of the rack 100 onto the rear pillar 60.

As illustrated in FIGS. 1 to 6, the bracket 70 is formed by, for example, press working a metal plate or joining metal plates. The bracket 70 may be a molded part made of a resin or a cut-machined part made of a metal.

The bracket 70 includes a vehicle fixing portion 72, an additional-component fixing portion 76, and a coupling portion 74.

The vehicle fixing portion 72 is a portion fixed to the pillar main body 62. The vehicle fixing portion 72 is, for example, plate-shaped. The vehicle fixing portion 72 is, for example, shaped as a plate that can contact a rear-facing surface of the square tube 63. The width of the vehicle fixing portion 72 may be smaller than or equal to the width of the square tube 63.

The vehicle fixing portion 72 is fixed to the pillar main body 62, for example, in the following manner.

Through holes 63h (also referred to as bolt holes 63h) are formed in the square tube 63. The through holes 63h penetrate in the forward and backward direction. Specifically, the through holes 63h penetrate in the forward and backward direction that is a direction orthogonal to a longitudinal direction of the square tube 63.

The number of the through holes 63h penetrating the square tube 63 may be one or multiple. In this embodiment, the two through holes 63h are formed at different positions of the square tube 63 along the longitudinal direction.

Through holes 72h are also formed in the vehicle fixing portion 72. The two through holes 72h may be formed to correspond to the two through holes 63h.

A portion around the through holes 63h in the rear-facing surface of the square tube 63 is a mounting target surface 63F. The vehicle fixing portion 72 is disposed behind the pillar main body 62 such that the vehicle fixing portion 72 is in surface contact with this mounting target surface 63F. In this state, the two through holes 72h are disposed along extensions of the respective two through holes 63h.

Two screws or bolts S are disposed through the two through holes 63h and the two through holes 72h.

One of a head SH of the screw S and a nut N is disposed at the front of the square tube 63, and the other is disposed at the rear of the vehicle fixing portion 72. One of the screw S and the nut N may be fixed to the square tube 63 or the vehicle fixing portion 72 in advance.

Threadably engaging the screw S with the nut N sandwiches the square tube 63 and the vehicle fixing portion 72 between the head SH and the nut N. This fixes the vehicle fixing portion 72 to the pillar main body 62. In this embodiment, threadably engaging the screw S with the nut N to fasten the screw S to the nut N or releasing the engagement allows the vehicle fixing portion 72 to be detachably mounted on the square tube 63.

The additional-component fixing portion 76 is a portion to which an additional component is fixed. The additional-component fixing portion 76 includes an additional-component fixing hole 76h. The additional-component fixing portion 76 is, for example, plate-shaped. The additional-component fixing hole 76h is a hole penetrating the additional-component fixing portion 76 in a thickness direction.

The additional-component fixing hole 76h may penetrate the additional-component fixing portion 76 in a direction crossing the longitudinal direction of the rear pillars 60.

An additional component can be fixed to the bracket 70 using the additional-component fixing hole 76h.

The additional-component fixing hole 76h is a hole suitable for detachably mounting an additional component on the bracket 70. The additional-component fixing hole 76h may be, for example, a hole suitable for fixing an additional component using the clamp 80, or a hole suitable for fixing the additional component using screws.

In this embodiment, the additional-component fixing hole 76h is a hole suitable for fixing an additional component using the clamp 80. The additional-component fixing hole 76h may be larger than a hole for fixing a screw. The additional-component fixing hole 76h may be larger than, for example, the through hole 72h. The additional-component fixing hole 76h may be, for example, an opening longer in one direction. For example, the additional-component fixing portion 76 may be plate-shaped in the upward and downward direction, and the additional-component fixing hole 76h may be, for example, an opening longer in the upward and downward direction. The additional-component fixing hole 76h may be shaped into a rectangle with round corners. Both ends of the additional-component fixing hole 76h in the longitudinal direction may have a shape gradually narrowed toward the outside in the longitudinal direction.

The clamp 80 fixes the additional component to the additional-component fixing portion 76 with the clamp 80 being caught by the outer edge of the additional-component fixing hole 76h from the vehicle fixing portion 72 side, while penetrating the additional-component fixing hole 76h.

A surface of the additional-component fixing portion 76 which faces opposite the vehicle fixing portion 72 is a mounting surface 76F. The mounting surface 76F is a surface behind the pillar main body 62 and in contact with an additional component. Since the additional component is in contact with the mounting surface 76F, the additional component is easily disposed behind the pillar main body 62. Thus, the additional component hardly interferes with the pillar main body 62.

The coupling portion 74 couples the vehicle fixing portion 72 with the additional-component fixing portion 76 with space. Since the clamp 80 is caught by the outer edge of the additional-component fixing hole 76h from the vehicle fixing portion 72 side, the clamp 80 is incorporated between the vehicle fixing portion 72 and the additional-component fixing portion 76 in the fixing operation and after the fixing. Since the vehicle fixing portion 72 is spaced from or spaced apart from the additional-component fixing portion 76, the space for incorporating the clamp 80 between the vehicle fixing portion 72 and the additional-component fixing portion 76 can be reserved.

The coupling portion 74 may be a portion obtained by press working a metal plate, and may have a tubular shape connecting the outer edge of the vehicle fixing portion 72 with the outer edge of the additional-component fixing portion 76. The coupling portion 74 may have a partial opening 74h. The coupling portion 74 may be connected to a part of a perimeter of the vehicle fixing portion 72. The coupling portion 74 may be connected to a part of a perimeter of the additional-component fixing portion 76. A triangle rib 76b for reinforcement may be formed in a portion in which the coupling portion 74 is connected to the vehicle fixing portion 72 or the additional-component fixing portion 76.

The coupling portion 74 may have a tubular shape which varies between the vehicle fixing portion 72 and the additional-component fixing portion 76.

In this embodiment, the additional-component fixing portion 76 extends larger than the vehicle fixing portion 72. For example, the additional-component fixing portion 76 is wider than the vehicle fixing portion 72. For example, the vertical length of the additional-component fixing portion 76 is larger than that of the vehicle fixing portion 72.

Since the additional-component fixing portion 76 extends larger than the vehicle fixing portion 72, the area of the additional component in contact with the vehicle fixing portion 72 increases. This allows the additional component to be stably in contact with the vehicle fixing portion 72. Furthermore, the additional-component fixing hole 76h, which tends to be larger than a hole for screwing and is intended for fixing the clamp 80, can be easily formed in the additional-component fixing portion 76.

The coupling portion 74 may have a tubular shape gradually expanding from the vehicle fixing portion 72 toward the additional-component fixing portion 76, according to the sizes of the vehicle fixing portion 72 and the additional-component fixing portion 76.

The coupling portion 74 may expand near the vehicle fixing portion 72 more steeply than near the additional-component fixing portion 76. In this case, the internal space of the coupling portion 74 easily extends near the additional-component fixing portion 76. Thus, the space for fixing the clamp 80 is easily reserved near the additional-component fixing portion 76.

The bracket 70 that is an example mounting portion may face rearward of the vehicle main body 22 with the bracket 70 being mounted on the pillar main body 62.

The bracket 70 facing rearward of the vehicle main body 22 may mean that the additional-component fixing hole 76h faces rearward.

The orientation of the mounting surface 76F is discretionary. The mounting surface 76F may extend along the vertical direction that is the direction of gravity. In other words, the mounting surface 76F may be a surface facing directly rearward.

For example, when the mounting surface 76F extends along the vertical direction, an additional component is easily mounted on the bracket 70 with respect to the vertical direction as a reference. For example, when the mounting surface is oblique with respect to the vertical direction, pressing the additional component against the mounting surface along the horizontal direction displaces the additional component upward or downward. Thus, the additional component may be hardly positioned at a fixed position. When the mounting surface 76F extends along the vertical direction, pressing the additional component against the mounting surface 76F along the horizontal direction stabilizes the position of the additional component. This state can facilitate an operation of fixing the additional component to the bracket 70 using, for example, the clamp 80. Similarly, this state can facilitate an operation of removing the clamp 80 while the additional component is pressed against the mounting surface 76F along the horizontal direction, and an operation of removing the additional component from the bracket 70.

The vehicle fixing portion 72 in contact with the pillar main body 62 extends obliquely upward and rearward, and the additional-component fixing portion 76 extends in the vertical direction. Thus, the additional-component fixing portion 76 is inclined with respect to the vehicle fixing portion 72. In other words, the coupling portion 74 couples the vehicle fixing portion 72 and the additional-component fixing portion 76 in respective oblique orientations. This disposes the additional-component fixing portion 76 in a vertical orientation with respect to the pillar main body 62 in the oblique orientation.

Each of the rear pillars 60 may include a positioning portion 79 that positions an additional component at a position corresponding to a mounting portion. For example, the bracket 70 may include the positioning portion 79.

The positioning portion 79 may be a positioning protrusion or a positioning recess.

The bracket 70 according to this embodiment includes a positioning protrusion as the positioning portion 79. The positioning portion 79 may be, for example, a piece protruding opposite the vehicle fixing portion 72. The end of the positioning portion 79 may be oriented in a direction away from the additional-component fixing hole 76h. The positioning portion 79 may be, for example, a piece extending obliquely upward and rearward from the upper end of the additional-component fixing portion 76. Locking the positioning portion 79 at an additional component before the additional component is fixed using the clamp 80 may temporarily position the additional component at the additional-component fixing portion 76. In this temporarily positioning state, the additional component may be fixed to the additional-component fixing portion 76 using the clamp 80. The positioning portion 79 may be, for example, a piece partially extending from an outer edge of the coupling portion 74 of the bracket 70 which encloses the additional-component fixing portion 76.

The mounting portions included in the rear pillars 60 may include an upper mounting portion and a lower mounting portion. The lower mounting portion is lower than the upper mounting portion.

In this embodiment, the bracket 70 as an example upper mounting portion is fixed to the pillar main body 62. A bracket 70B as an example lower mounting portion is fixed to the pillar main body 62.

The brackets 70 and 70B may be spaced from each other along the longitudinal direction of the pillar main body 62.

The brackets 70 and 70B may have the same shape or different shapes.

In this embodiment, the bracket 70B includes a vehicle fixing portion 72B, an additional-component fixing portion 76B, and a coupling portion 74B similarly to the bracket 70.

The bracket 70B differs from the bracket 70 in that a distance between the vehicle fixing portion 72B and the additional-component fixing portion 76B is less than that between the vehicle fixing portion 72 and the additional-component fixing portion 76 and thus the coupling portion 74B is shorter than the coupling portion 74.

Fixing the brackets 70 and 70B to the pillar main body 62 vertically at different positions can stably fix an additional component to the pillar main body 62 using the upper and lower brackets 70 and 70B. Alternatively, additional components can be fixed vertically at different positions, using the brackets 70 and 70B.

The rear pillars 60 may include a right rear pillar 60R and a left rear pillar 60L. When the right and left rear pillars 60 are distinguished from each other, the right and left rear pillars 60 are sometimes distinguished as the right rear pillar 60R and the left rear pillar 60L with respective reference numerals.

Each of the right rear pillar 60R and the left rear pillar 60L may include the bracket 70 that is an example mounting portion. In this case, the right rear pillar 60R and the left rear pillar 60L may support the brackets 70 at the same height position.

Consequently, the right and left brackets 70 at the same height position stably and easily support an additional component.

Each of the right rear pillar 60R and the left rear pillar 60L may include the bracket 70B that is an example lower mounting portion. In this case, the right rear pillar 60R and the left rear pillar 60L may support the brackets 70B at the same height position.

Inclusion of the upper and lower brackets 70 and 70B in the right rear pillar 60R and inclusion of the upper and lower brackets 70 and 70B in the left rear pillar 60L can stably fix an additional component to the right and left rear pillars 60R and 60L using at least four portions as positioning reference.

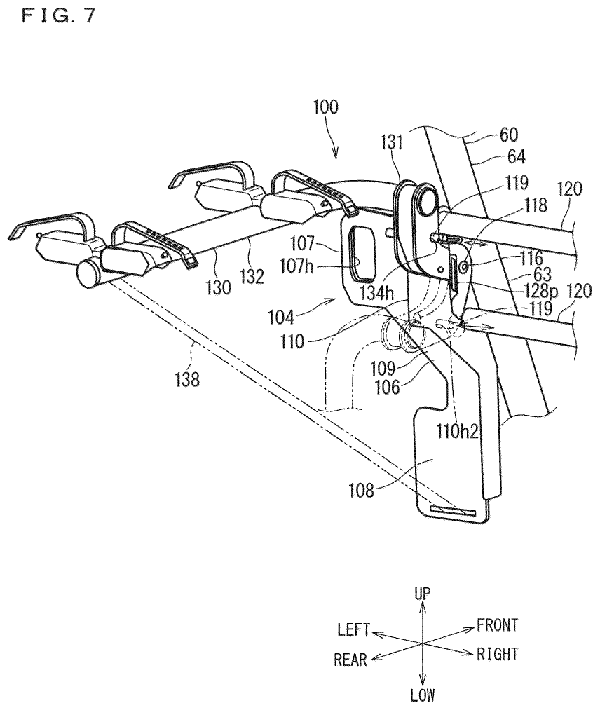

A structure of the rack 100 as an example additional component will be described. FIG. 7 is a perspective view illustrating a mounting portion of the rack 100 onto the rear pillar 60 when viewed from the inside in the vehicle-width direction.

As illustrated in FIGS. 1 to 4, 6, and 7, the rack 100 includes a base 102 and the variable arms 130.

The base 102 is a portion supported at fixed positions of the rear pillars 60. The variable arm 130 is a portions supported by the base 102 variably or movably between first and second positions.

The base 102 includes mounting bases 104. The base 102 according to this embodiment includes the right and left mounting bases 104. The base 102 may include only the one mounting base 104.

The mounting base 104 includes a contact mounting portion 106 and an arm supporter 110. The contact mounting portion 106 is a portion to be mounted in contact with the bracket 70. The arm supporter 110 is a portion supporting the variable arm 130 at a variable position.

The contact mounting portion 106 is formed by, for example, press working a metal plate. The contact mounting portion 106 includes a portion extending along the vertical direction. The contact mounting portion 106 includes, for example, an upper contact portion 107 and a lower contact portion 108. The upper contact portion 107 and the lower contact portion 108 extend along the vertical direction and the vehicle-width direction. One main surface of the upper contact portion 107 and the lower contact portion 108 faces forward, and the other main surface faces rearward. The upper contact portion 107 is located behind the lower contact portion 108 in the forward and backward direction. The upper contact portion 107 and the lower contact portion 108 are connected through an inclined portion 109. The inclined portion 109 extends obliquely rearward and upward from the upper end of the lower contact portion 108, and is continuous to the lower end of the upper contact portion 107.

A fixing hole 107h is formed in the upper contact portion 107. The fixing hole 107h is formed as an opening longer in one direction. The fixing hole 107h may be, for example, an opening with the same shape as that of the additional-component fixing hole 76h.

The upper contact portion 107 is superimposed on the mounting surface 76F of the additional-component fixing portion 76 of the upper bracket 70 such that the fixing hole 107h and the additional-component fixing hole 76h become continuous openings. In this state, the upper contact portion 107 is in surface contact with the mounting surface 76F.

In this state, the lower contact portion 108 is in surface contact with the mounting surface 76F of the lower bracket 70B.

The upper contact portion 107 and the lower contact portion 108 are formed into shapes for avoiding the positioning portion 79.

While the upper contact portion 107 is superimposed on the additional-component fixing portion 76, the mounting base 104 is fixed to the bracket 70.

Here, an example of the clamp 80 will be described.

The clamp 80 is a fixing device that can be locked at the outer edge of a fixing hole from both sides of the fixing hole in a direction of penetrating the fixing hole, when being clamped while penetrating the fixing hole. While plate-shaped portions with respective fixing holes overlap one another, the clamp 80 is locked at the outer edges of the continuous fixing holes from both sides of the fixing holes in the penetrating direction to maintain the overlapping plate portions.

The clamp 80 may be, for example, attached to or detached from the additional-component fixing hole 76h and the fixing hole 107h through a quick operation. Here, the quick operation is an operation simpler than an operation of fastening or unfastening a screw, and is, for example, a combined operation of two unidirectional operations or one unidirectional operation. The unidirectional operation is an operation in one direction which does not involve an operation in a return direction, and may be a rotation operation, a pressing operation, a pulling operation, a push-up operation, or a moving operation in a lateral direction. The operation in one direction which does not involve the operation in the return direction is, for example, an operation to be performed by twisting the wrist once, e.g., a rotation operation at 180 degrees or less. The quick operation is preferably an operation executable without any tool, which is not essential. For example, the quick operation may be performed using a tool that doubles as a key function.

The clamp 80 may be, for example, attached to or detached from the additional-component fixing hole 76h and the fixing hole 107h, by holding its operating part with the hand and operating the operating part without any tool.

As illustrated in FIGS. 4 and 6, the clamp 80 includes, for example, a base 82, retaining portions 84, a penetrating portion 86, and an operating part 88.

The base 82 is sized to the extent that the base 82 cannot pass through the additional-component fixing hole 76h and the fixing hole 107h. The base 82 is sized, for example, longer than a longitudinal dimension of each of the additional-component fixing hole 76h and the fixing hole 107h that are slender, and larger than a width of each of the additional-component fixing hole 76h and the fixing hole 107h.

The penetrating portion 86 protrudes from the base 82 to penetrate the additional-component fixing hole 76h and the fixing hole 107h.

The retaining portions 84 are located at the ends of the penetrating portion 86. The retaining portions 84 are repositionable between a state in which the retaining portions 84 can pass through the additional-component fixing hole 76h and the fixing hole 107h and a state in which the retaining portions 84 cannot pass through the additional-component fixing hole 76h and the fixing hole 107h. For example, the two retaining portions 84 can protrude and retract move from the ends of the penetrating portion 86 in a direction orthogonal to the longitudinal direction of the penetrating portion 86. The retaining portions 84 protrude from the penetrating portion 86, so that the retaining portions 84 at the ends of the penetrating portion 86 are locked at the outer edge of the additional-component fixing hole 76h, and cannot be escaped from the additional-component fixing hole 76h and the fixing hole 107h. The retaining portions 84 retract from the protruding state and moves back to the penetrating portion 86, so that the penetrating portion 86 and the retaining portions 84 can penetrate or escape from the additional-component fixing hole 76h and the fixing hole 107h.

The operating part 88 is operably supported opposite the penetrating portion 86 with respect to the base 82. An operation on the operating part 88 is, for example, a rotation operation. A rotation operation on the operating part 88 is transmitted to the retaining portions 84 through an operation transmission mechanism in the penetrating portion 86. The retaining portions 84 protrude and retract according to the rotation operation on the operating part 88.

The clamp 80 may have a structure except the aforementioned structure. For example, protruding portions may be rotably supported with respect to a base, and the protruding portions may be rotationally operated through an operation on an operating part. Furthermore, the protruding portions may have a structure such that the protruding portions can pass through the additional-component fixing hole 76h and the fixing hole 107h or can be locked at the outer edge of the additional-component fixing hole 76h, according to the rotation positions of the protruding portions.

Furthermore, the base 102 may be fixed to the bracket 70 using screws.

The penetrating portion 86 and the retaining portions 84 of the clamp 80 penetrate the additional-component fixing hole 76h and the fixing hole 107h, and the mounting base 104 is disposed on a rear-facing surface of the upper contact portion 107, while the upper contact portion 107 is superimposed on the additional-component fixing portion 76. In this state, the retaining portions 84 pass through the additional-component fixing hole 76h and the fixing hole 107h, and are disposed in the space between the vehicle fixing portion 72 and the additional-component fixing portion 76. Operating the operating part 88 in this state causes the retaining portions 84 to protrude from the penetrating portion 86. Then, the retaining portions 84 are locked at the outer edge of the additional-component fixing hole 76h from the vehicle fixing portion 72 side. Thus, the outer edge of the additional-component fixing hole 76h in the additional-component fixing portion 76 and the outer edge of the fixing hole 107h of the upper contact portion 107 are sandwiched between the base 82 and the retaining portions 84. This fixes the upper contact portion 107 to the bracket 70.

The lower contact portion 108 is located below and in front of the upper contact portion 107, and is in contact with the mounting surface 76F of the lower bracket 70B from the rear. In this embodiment, the lower contact portion 108 is merely in contact with the bracket 70B, and is not fixed using a clamp or a screw. The lower contact portion may be fixed to the bracket using, for example, a clamp or a screw. The contact portion may be hooked onto the bracket with a hook.

As illustrated in FIGS. 1 to 3, and FIGS. 4 and 6, the arm supporter 110 is fixed to the mounting base 104. The fixing structure may be, for example, screwing or welding. The arm supporter 110 is, for example, a plate-shaped component. The arm supporter 110 is located inside the mounting base 104 in the vehicle-width direction. The arm supporter 110 is along the forward and backward direction and the vertical direction.

The arm supporter 110 rotatably supports a base end of the variable arm 130 through a spindle 118. This supports the variable arm 130 repositionably between the first and second positions. The first position may be a position suitable for the variable arm 130 to support a load, and the second position may be a position at which the protruding dimension of the variable arm 130 from the vehicle main body 22 is reduced. The second position may be an orientation closer to the vertical direction with respect to the first position. In this embodiment, the first position is an orientation in which the variable arm 130 extends along the horizontal direction. The second position is an orientation in which the variable arm 130 approaches the vertical direction with respect to the first position, for example, an orientation in which the variable arm 130 extends along the vertical direction.

The axis of the spindle 118 extends along the vehicle-width direction. In other words, the variable arm 130 can oscillate at a fixed position in the vehicle-width direction. This can prevent the variable arm 130 from protruding outside in the vehicle-width direction, even when the variable arm 130 is displaced. Thus, the space occupied by the additional component in the vehicle-width direction is hardly increased.

An axis cover 116 may surround the base end of the variable arm 130.

The base 102 may further include middle frames 120 extending along the vehicle-width direction. For example, the middle frames 120 couple the right and left arm supporters 110 in the vehicle-width direction with space. The number of the middle frames 120 is discretionary. In this embodiment, the middle frames 120 that are separated in the upward and downward direction couple the right and left arm supporters 110. The right and left mounting bases 104 are kept apart to correspond to the space between the right and left pillar main bodies 62.

The middle portions of the upper and lower middle frames 120 in the longitudinal direction may be coupled together through a vertical frame 122. The back rest portion 46 of the second seat 40 can be flipped up about a pivot axis of an upper end of the back rest portion 46. In this case, the frames of the rack 100, for example, the middle frames 120 may be disposed lower than the flipped-up back rest portion 46. Furthermore, a mounting portion for an additional component, for example, the bracket 70 may be disposed lower than the pivot axis of the back rest portion 46.

The base 102 may include middle additional component supporters 124. The base 102 includes, for example, a support piece 128P with a slit, at the rear end of each of the right and left axis covers 116. The middle additional component supporters 124 are belts. The middle additional component supporters 124 are inserted into the slits of the right and left support pieces 128P, and are hung on the vertical frame 122. The middle additional component supporters 124 can extend rearward into a U shape between the left support piece 128P and the vertical frame 122 and between the right support piece 128P and the vertical frame 122. Portions of the middle additional component supporters 124 which extend rearward into the U shape can support an additional component. For example, when the load 300 placed on the lower rack 200 is higher than or equal to the middle frames 120, the portions of the middle additional component supporters 124 which extend rearward into the U shape may tie the load 300 and support the load 300 to keep the load 300 from falling over.

The middle additional component supporter may include a buckle that detachably couples a part of the belt with the remaining portion, or an adjuster that can adjust the length of the belt. The belt may be a belt with a stiffness enough to hold a certain path or a belt flexible enough to sag.

The variable arms 130 are elongated components. Each of the variable arms 130 includes, for example, an arm main body 132 and an arm base end 131.

The arm main body 132 includes a rod linearly extending, and a bent portion with one end connected to the rod. The bent portion is bent in a quarter-circular arc.

The arm base end 131 is a portion extending from an outer end of the bent portion in a direction orthogonal to the outer end. The arm base end 131 may be bent in a middle portion, or a portion extending straight.

The arm supporter 110 rotatably supports the end of the arm base end 131 through the spindle 118. The arm base end 131 is displaced inside the arm supporter 110 in the vehicle-width direction. The end of the bent portion of the arm main body 132 extends rearward of a rear side edge of the arm supporter 110. The arm main body 132 is bent at the bent portion outward from the rear end of the arm base end 131 in the vehicle-width direction, and extends rearward or downward from the end of the bent portion. Supporting the arm main body 132 at the end of the arm base end 131 which extends rearward allows the arm main body 132 to be displaced while avoiding an interference with the arm supporter 110.

The rack 100 may further include a retaining structure that is detachably inserted into the base 102 and retains the variable arms 130 selectively at the first and second positions.

For example, a pin mounting hole 134h is formed in the variable arm 130. The pin mounting hole 134h is formed in, for example, the arm base end 131.

A first pin mounting hole 110h1 and a second pin mounting hole 110h2 are formed in the arm supporter 110. While the variable arm 130 is located at the first position, the first pin mounting hole 110h1 is formed at a position overlapping the pin mounting hole 134h. While the variable arm 130 is located at the second position, the second pin mounting hole 110h2 is formed at a position overlapping the pin mounting hole 134h.

While the variable arm 130 is located at the first position, a pin 119 is inserted into the first pin mounting hole 110h1 and the pin mounting hole 134h. This retains the variable arm 130 at the first position.

While the variable arm 130 is located at the second position, the pin 119 is inserted into the second pin mounting hole 110h2 and the pin mounting hole 134h. This retains the variable arm 130 at the second position.

When the variable arm 130 moves between the first and second positions, the pins 119 are detached from the mounting holes 110h1, 110h2, and 134h. This can rotate the variable arm 130 about the spindle 118.

The pins 119 are example fixing portions. The first pin mounting hole 110h1 and the second pin mounting hole 110h2 are example fixing-portion selectively receiving holes. The pin mounting hole 134h is an example fixing-portion receiving hole. The retaining structure is a structure including the fixing portions, the fixing-portion selectively receiving holes, and the fixing-portion receiving hole.

The right and left variable arms 130 are supported in a displaceable manner by the right and left mounting bases 104, respectively. The right and left variable arms 130 are located outward of the center in the vehicle-width direction. The right and left variable arms 130 may be located outward of a middle region that is one third of the vehicle main body 22 in the vehicle-width direction.

The right and left variable arms 130 may be located at positions of the right and left pillar main bodies 62 and located outward of the positions in the vehicle-width direction. When a compartment 22S is formed at the rear of the vehicle main body 22, the right and left variable arms 130 may be located outward of the compartment 22S in the vehicle-width direction. The linear portions of the right and left variable arms 130 may be located outward of the middle frames 120 in the vehicle-width direction.

Each of the variable arms 130 may include branch arms 134 protruding from the arm main body 132.

For example, a linear portion of the arm main body 132 supports the branch arms 134. The branch arms 134 protrude in a direction crossing the longitudinal direction of the arm main body 132, for example, a direction orthogonal to the longitudinal direction. The branch arms 134 may protrude at one side of the arm main bodies 132 in a width direction or protrude at both sides in the width direction. The number of the branch arms 134 is discretionary, and may be one or multiple.

In this embodiment, the branch arms 134 are supported at two linear portions of the arm main body 132. The branch arms 134 protrude at both sides of the arm main bodies 132 in the width direction.

The branch arms 134 can support the load 310. For example, the load 310 is hung on and supported by the branch arms 134. For example, different loads 310 are supported at both sides of the arm main body 132 in the width direction.

The branch arm 134 may include a stopper 135 for preventing coming-off. The stopper 135 includes, for example, a belt 135a and a secure pin 135b. The belt 135a is coupled to a portion of the branch arm 134 to be coupled to the arm main body 132. The secure pin 135b that fastens the belt 135a protrudes at the end of the branch arm 134. A hole for receiving the secure pin 135b is formed in the belt 135a.

The belt 135a is fastened by the secure pin 135b across the load 310, with the load 310 being hung on the branch arm 134. Consequently, the branch arm 134 and the belt 135a surround a portion of the load 310 which is hung on the branch arm 134, so that the portion is held to resist coming off from the branch arm 134.

The rack 100 may include elongated bodies 138 each of which connects the lower end of the mounting base 104 to the end of the variable arm 130. The elongated body 138 may be, for example, a belt. A slit is formed at the lower end of the contact mounting portion 106 to allow the elongated body 138 to pass through the slit. The elongated body 138 is coupled to the end of the variable arm 130. The elongated body 138 can extend obliquely rearward and upward from the lower end of the mounting base 104 toward the end of the variable arm 130, while the variable arm 130 is located at the first position. The elongated bodies 138 can regulate the position of the load 310 such that the load 310 hung on the branch arms 134 does not extend outwardly.

The elongated body 138 may include a buckle that detachably couples a part of the belt with the remaining portion, or an adjuster that can adjust the length of the belt.

The partitions 150 will be described as another example of the additional components.

As illustrated in FIGS. 1 to 3, the extension base 42b in the deployed state and the main base 42a can be used as a carrier. The extension base 42b and the main base 42a to be used as a carrier are disposed at positions lower than that of the additional-component fixing hole 76h.

The partitions 150 can partition the space above the extension base 42b and the main base 42a as a carrier.

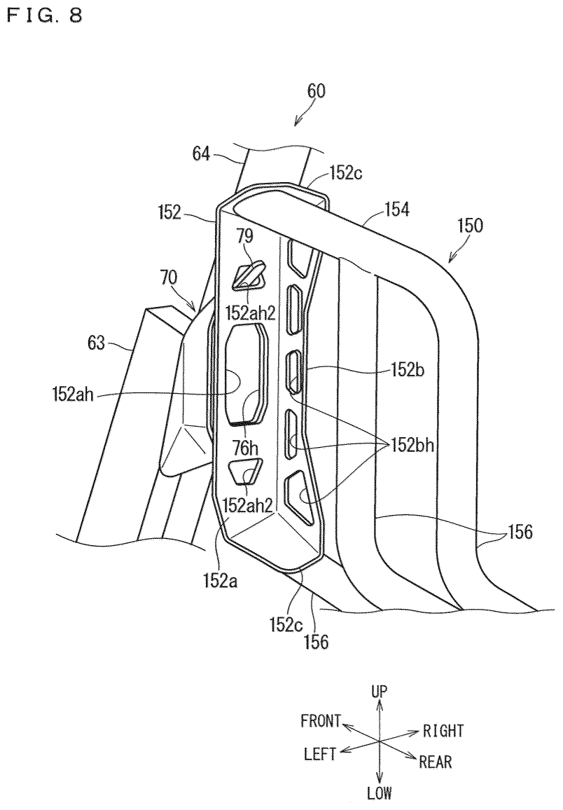

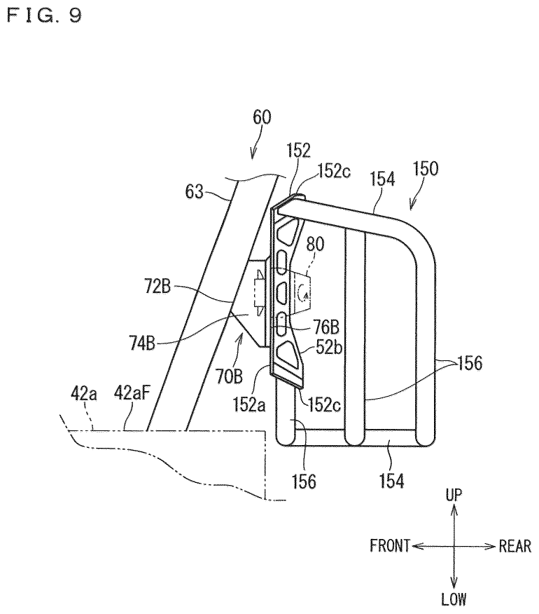

FIG. 8 is a perspective view illustrating a state in which the partition 150 is mounted on the upper bracket 70. FIG. 9 is a side view illustrating a state in which the partition 150 is mounted on the lower bracket 70B.

As illustrated in FIGS. 1 to 3 and FIGS. 8 and 9, for example, each of the partitions 150 includes a partition base 152, vertical rods 154, and horizontal rods 156.

The partition base 152 is located at a lower portion of the partition 150, and is a portion to be placed on the extension base 42b or the main base 42a.

In this embodiment, the partition base 152 includes a main plate 152a, a horizontal wall 152b, and two inclined walls 152c.

The main plate 152a is a slender plate. The horizontal wall 152b is mounted upright along one long side of the main plate 152a. The two inclined walls 152c are mounted upright at both sides of the main plate 152a in the longitudinal direction. The horizontal wall 152b and the two inclined walls 152c may be connected by, for example, welding.

The partition base 152 may be formed by, for example, press working a metal plate, or welding or screwing metal plates. The partition base 152, which has a three-dimensional structure including the main plate 152a, the horizontal wall 152b, and the two inclined walls 152c, is hardly deformed.

The middle portion of the horizontal wall 152b in the longitudinal direction may be lower than its front and rear portions. Thus, the operating part 88 of the clamp 80 does not easily interferes with the horizontal wall 152b.

Openings 152bh may be formed in the horizontal wall 152b. The openings 152bh may be used as portions for hooking a rope or a hook at the end of a wire for fixing the load. The load may be other than load 300 or load 310, or it may be load 300, or it may be load 310.

One of the horizontal rods 156 couples ends of the two partition bases 152 together. This maintains a parallel state of the two partition bases 152 with space. The vertical rods 154 are mounted upright with respect to the partition base 152 or the horizontal rod 156. The other horizontal rods 156 extend to couple the vertical rods 154 together, away from the partition bases 152.

The horizontal rods 156 and the vertical rods 154 form a U-shaped partition directed in three directions.

A fixing hole 152ah identical to the additional-component fixing hole 76h is formed in the main plate 152a. Additional-component fixing holes 42h identical to the additional-component fixing hole 76h are also formed in the extension base 42b and the main base 42a.

Thus, disposing the partition base 152 on the extension base 42b or the main base 42a to dispose the fixing hole 152ah on the additional-component fixing hole 42h detachably mounts the partition base 152 on the extension base 42b or the main base 42a using the clamp 80.

The horizontal rods 156 and the vertical rods 154 protrude into the space on the extension base 42b or the main base 42a, while the partition base 152 is mounted on the extension base 42b or the main base 42a. Thus, the partitions 150 partition the space above the extension base 42b or the main base 42a such that an object on the extension base 42b or the main base 42a hardly falls.

For example, when at least a part of the extension base 42b or the main base 42a is desirably used as a carrier without any partition or when the part is desirably used at the folded position, the partitions 150 are removed from the extension base 42b or the main base 42a. The removed partitions 150 may be mounted on the upper brackets 70 or the lower brackets 70B.

For example, while the partition base 152 is in surface contact with the mounting surface 76F of the upper bracket 70, the partition base 152 is fixed to the additional-component fixing portion 76 of the bracket 70 using the clamp 80.

The partition 150 as an additional component may include positioning recesses 152ah2. The positioning recess 152ah2 may be an opening or a recess with a bottom.

In this embodiment, the positioning recess 152ah2 is formed in the partition base 152. The positioning recess 152ah2 may be formed, for example, next to the fixing hole 152ah in the partition base 152. The fixing hole 152ah may be separated from the positioning recess 152 ah2 by 1 cm or 2 cm or more. The fixing hole 152 ah may be separated from the positioning recess 152 ah2 by 5 cm or 10 cm or more.

Positioning recesses 152ah2 may be formed in the partition base 152. For example, the positioning recesses 152ah2 may be formed, for example, on both sides of the fixing hole 152ah in the partition base 152. In other words, the fixing hole 152ah is located between the two positioning recesses 152ah2.

The partition base 152 is disposed in surface contact with the additional-component fixing portion 76 of the bracket 70 with the positioning portion 79 formed in the bracket 70 being locked at the upper positioning recess 152ah2. In this state, the additional-component fixing hole 76h and the fixing hole 152ah are disposed to overlap each other. In other words, the positioning portion 79 positions the partition 150 at a position corresponding to the bracket 70 that is a mounting portion, for example, at a position suitable for being mounted by the clamp 80. In this state, the partition 150 can be fixed to the bracket 70 using the clamp 80.

Since the positioning recesses 152ah2 are formed in the partition base 152, even when the partition 150 is mounted on the bracket 70 in a vertically different orientation, the positioning portion 79 can position the partition base 152.

The partition 150 can be fixed to the lower bracket 70B. As illustrated in FIG. 9, the partition 150 is disposed along a rear extension of the main base 42a as a carrier while the partition 150 is fixed to the lower bracket 70B. The partition 150 may include a portion located at the same height position as the main base 42a and extending along the horizontal direction. For example, a portion of the horizontal rods 156 which connects the right and left partition bases 152 of the partitions 150 is disposed along a rear extension of the main base 42a. Thus, the partitions 150 can support a load placed on the main base 42a, behind the main base 42a from the bottom. The main base 42a and a portion of the partition 150 which is located along the rear extension of the main base 42a may be vertically displaced to the extent that a load can be supported, for example, vertically displaced within a range of 5 cm, 3 cm, or 2 cm.

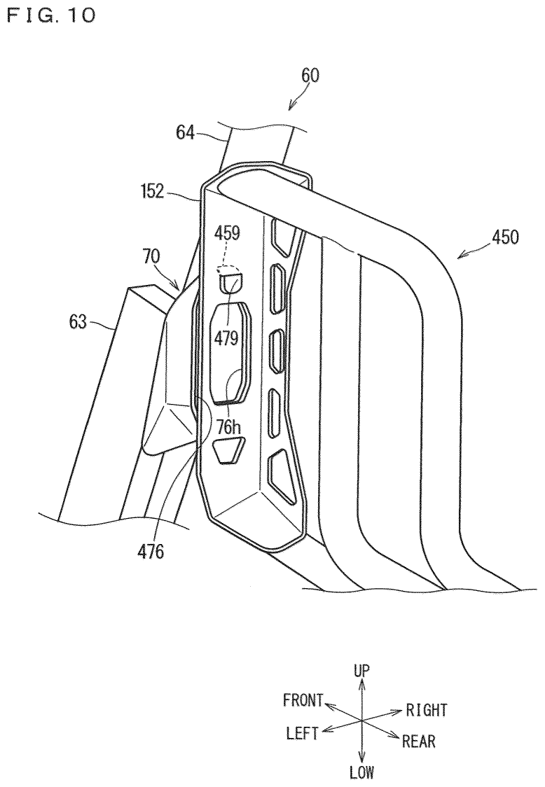

As illustrated in FIG. 10, an additional-component fixing portion 476 corresponding to the additional-component fixing portion 76 may include a positioning recess 479 as a positioning portion. Here, a partition 450 corresponding to the partition 150 as an additional component may include a positioning protrusion 459 that is locked at the positioning recess 479.

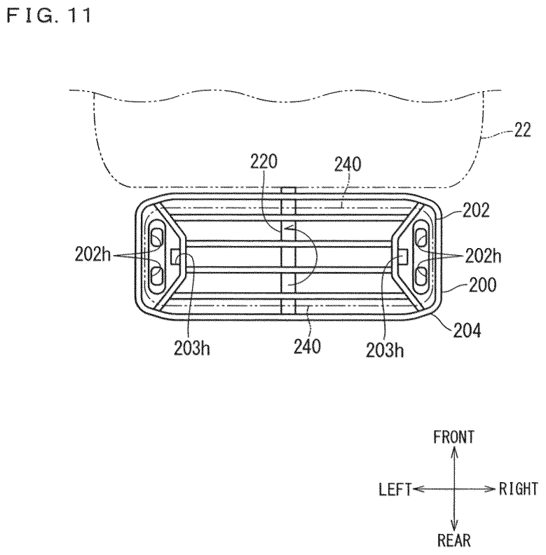

FIG. 11 is a plan view illustrating the lower rack 200 located behind the vehicle main body 22.

As illustrated in FIGS. 1, 2, and 11, the lower rack 200 is a component including a bottom 202 and a peripheral wall 204. The load 300 can be placed on the lower rack 200.

The lower rack 200 includes, for example, a mounting rod 220 extending forward from the bottom 202. A tube 22E into which the mounting rod 220 can be inserted is supported at the bottom of the vehicle main body 22. Insertion of the mounting rod 220 into the tube 22E allows the lower rack 200 to be supported at a position behind the vehicle main body 22 and separated above a road surface. The tube 22E includes a screw hole penetrating inside and outside thereof. A screw S may be threadably engaged with the screw hole to restrain the movement of the mounting rod 220 in the tube 22E. For example, the end of the screw S may be pressed against an outer peripheral surface of the mounting rod 220, or fitted into a recess formed in the mounting rod.

An additional-component fixing hole 202h identical in shape to the additional-component fixing hole 76h may be formed in the bottom 202. An additional component 240 such as a fence component may be fixed to the lower rack 200 using the additional-component fixing hole 202h. The additional-component fixing holes 202h may be formed at portions in the forward and backward direction. Here, appropriately selecting positions of the additional-component fixing holes 202h used for fixation can adjust a fixed position of the additional component 240. Furthermore, appropriately selecting the positions can easily adjust a fixed orientation of the additional component 240. For example, this can easily adjust whether to locate a fence portion of a fence component closer to the front or the rear of the lower rack 200.

Furthermore, a restiform body such as a rope tied on a load placed on the bottom 202 is fixed using the additional-component fixing holes 202h. For example, a hook of a rope may be hooked on the additional-component fixing hole 202h. For example, an additional component with a portion to which a rope is fixed may be fixed to the additional-component fixing hole 202h, and the rope may be fixed to the additional component. The use of the additional-component fixing holes 202h brings fixing portions of the rope closer to the middle of the peripheral wall 204 than both ends thereof in the vehicle-width direction. This facilitates supporting a load at a fixed position in the vehicle-width direction, and improves the stability of a fixed state of the load.

The bottom 202 may include recesses 203h hooked by hooks for fixing a load. The recesses 203h may be located inward of the peripheral wall 204. Locating the recesses 203h inward of the peripheral wall 204 facilitates stably fixing the load.

For example, a rope tied on a load is hooked on the recesses 203h located inward of both ends of the peripheral wall 204 in the vehicle-width direction. This facilitates supporting the load at a fixed position in the vehicle-width direction, and improves the stability of the fixed state of the load. The rope on the load may be fixed using the additional-component fixing holes 202h or fixed to the recesses 203h.

The lower rack 200 with the additional-component fixing holes 202h and the recesses 203h easily supports loads with different sizes and shapes. The lower rack 200 supports, for example, a golf bag using the additional-component fixing holes 202h, or a cooler box using the recesses 203h.

In this embodiment, the rear pillars 60 include mounting portions. This facilitates mounting additional components on the vehicle 10, using the mounting portions.

Various additional components can be additionally fixed to the rear of the vehicle body 20, using the mounting portions.

The mounting portion with the additional-component fixing hole 76h penetrating in a direction crossing the longitudinal direction of the rear pillar 60 can facilitate mounting the additional component on the vehicle 10, using the additional-component fixing hole 76h.

Making the mounting portion face the rear of the vehicle main body 22 can prevent the additional component from protruding outside in the vehicle-width direction, and reduces the influence of mounting the additional component on the driving.

Furthermore, the rear pillar 60 includes the pillar main body 62 and the bracket 70. A mounting portion is the bracket 70 which includes the mounting surface 76F located behind the pillar main body 62. This facilitates preventing an interference between the pillar main body 62 and an additional component.

Furthermore, extension of the mounting surface 76F along the vertical direction facilitates attaching or detaching an additional component more than that when the mounting surface 76F is obliquely disposed with respect to the vertical direction.

Furthermore, the bracket 70 has a structure in which the coupling portion 74 couples the vehicle fixing portion 72 with the additional-component fixing portion 76 with space, and the additional-component fixing portion 76 includes the additional-component fixing hole 76h. This facilitates fixing an additional component to the vehicle 10 while the orientation and the position of the pillar main body 62 hardly influence the additional component.

Furthermore, incorporating, in the rack 100 that is an example additional component, the base 102 and the variable arms 130 supported by the base 102 variably between the first and second positions facilitates improving the convenience. For example, disposing the variable arms 130 at the first position that is approximately horizontal facilitates supporting a load. The variable arms 130 disposed at the second position that is an approximately vertical orientation hardly protrude from the vehicle body 20.

The rack 100 includes a structure including the secure pins 119 which are detachably inserted into the base 102 as a retaining structure for retaining the variable arms 130 selectively at the first and second positions. This facilitates retaining the variable arms 130 selectively at the first and second positions.

Since the variable arms 130 are located outward of the center in the vehicle-width direction of the vehicle main body 22, the variable arms 130 are easily changed from the first position to the second position, while an interference between the load 300 placed in the vicinity of the center in the vehicle-width direction and the variable arms 13 is prevented. Furthermore, the variable arms 130 easily support the load 310 at both outside portions of the load 300 in the vehicle-width direction, while the load 300 is supported in the center in the vehicle-width direction.

The variable arms 130 each of which includes the arm main body 132 and the branch arms 134 support many loads 310 using the branch arms 134.

Furthermore, the rack 100, which includes the middle frames 120 extending along the vehicle-width direction, easily supports a load placed in the vicinity of the center in the vehicle-width direction, using the middle frames 120. For example, the rack 100 supports at least a part of the middle additional component supporters 124 using the middle frames 120, and the middle additional component supporters 124 easily support the load 300.

Furthermore, the rear pillar 60 includes the positioning portion 79. This can mount the partition 150 that is an additional component on the rear pillar 60, with the partition 150 being positioned by the positioning portion 79. Thus, an operation of mounting the partition 150 is simplified.

The positioning portion 79 is a positioning protrusion. When the end of the positioning protrusion is oriented in a direction away from the additional-component fixing hole 76h, the additional component is hooked on the positioning protrusion, and is brought closer to the additional-component fixing hole 76h. This facilitates positioning the additional component.

Furthermore, the partition 150 is fixed to the rear pillar 60 while being disposed along the rear extension of the main base 42a. Thus, the partition 150 that can partition the space above the main base 42a can be used as a support base along the rear extension of the main base 42a.

Furthermore, the right and left rear pillars 60R and 60L include the respective brackets 70 as mounting portions supported at the same height position. Thus, additional components are easily mounted on the rear pillars 60R and 60L using the right and left brackets 70.

Furthermore, since the mounting portions include the upper bracket 70 and the lower bracket 70B, the brackets 70 and 70B can be selected at appropriate height positions for each additional component, or additional components can be mounted using the upper bracket 70 and the lower bracket 70B.

When the additional-component fixing portion 76 of the bracket 70 extends larger than the vehicle fixing portion 72, an additional component is stably mounted on the additional-component fixing portion 76 using the wider additional-component fixing portion 76.

When the additional-component fixing portion 76 is inclined with respect to the vehicle fixing portion 72, the inclination of the additional-component fixing portion 76 can be set different from that of a surface to which the vehicle fixing portion 72 is fixed, for example, a rear-facing surface of the pillar main body 62. Thus, an orientation of the additional-component fixing portion 76 is easily set to an orientation appropriate for fixing an additional component, irrespective of the inclination of the pillar main body 62.

### Modifications

The aforementioned embodiment describes the example in which each of the rear pillars 60 includes the pillar main body 62 and the bracket 70, the bracket 70 is a mounting portion, and an additional component is detachably mounted on the bracket 70.

However, the bracket 70 may be understood as an additional component. In other words, it may be understood that the rear pillar 60 is the pillar main body 62 and the bracket 70 is detachably mounted on the pillar main body 62 as an additional component. Here, a portion of the rear pillar 60 in which a screwing hole is formed may be understood as a mounting portion.

When the pillar main body 62 itself has a mounting portion, a positioning protrusion or a positioning recess may be formed in the pillar main body 62 itself as a positioning portion.

Furthermore, the bracket 70 may be omitted, and an additional component may be directly and detachably mounted on the pillar main body 62 through screws or a clamp. Here, the portion of the rear pillar 60 in which the screwing hole is formed may be understood as a mounting portion.

The aforementioned embodiment describes the example in which the variable arms 130 move in an oscillating manner between the first and second positions. The structure in which the variable arms move is not limited to the aforementioned example. For example, the variable arms may translate between the first and second positions. For example, tilting movement of the variable arms may be added to the translation of the variable arms. Such movements can be achieved by, for example, a link mechanism. Displacement of the variable arms 130 between the first and second positions may be telescopic displacement in which the existing length positions are changed. The telescopic displacement can be achieved by a telescopic structure.

The structures described in the embodiment and the modifications can be appropriately combined unless any contradiction occurs.

### Appendixes

This application and drawings disclose the following aspects.

A vehicle according to a first aspect comprises: a vehicle main body; and at least one rear pillar extending upward with respect to the vehicle main body, the rear pillar including at least one mounting portion to which at least one additional component is detachably mountable.

Here, the rear pillar includes the mounting portion. This facilitates mounting the additional component on the vehicle, using the mounting portion.

A second aspect is the vehicle according to the first aspect, wherein the mounting portion includes an additional-component fixing hole penetrating in a direction crossing a longitudinal direction of the rear pillar.

This can facilitate mounting the additional component on the vehicle, using the additional-component fixing hole.

A third aspect is the vehicle according to the first or the second aspect, the vehicle further comprising the additional component fixed to the rear pillar using the mounting portion.

This can fix various components to the rear of the vehicle body.

A fourth aspect is the vehicle according to one of the first to third aspects, wherein the mounting portion faces rearward of the vehicle main body.

This can prevent the additional component from protruding outside in the vehicle-width direction, and reduce the influence of mounting the additional component on the driving.

A fifth aspect is the vehicle according to any one of the first to fourth aspects, wherein the rear pillar includes a pillar main body and a bracket, the pillar main body is inclined rearward as progressing upward, and the mounting portion includes a mounting surface located behind the pillar main body and in contact with the additional component.

This prevents an interference between the pillar main body and the additional component.

A sixth aspect is the vehicle according to the fifth aspect, wherein the mounting surface extends along a vertical direction.

In this case, the additional component is more easily attached or detached than when the mounting surface is non-vertically disposed.

A seventh aspect is the vehicle according to any one of the second to sixth aspects, wherein the rear pillar includes a pillar main body and a bracket, the bracket including: a vehicle fixing portion fixed to the pillar main body; an additional-component fixing portion to which the additional component is fixed; and a coupling portion coupling the vehicle fixing portion with the additional-component fixing portion with space, and the additional-component fixing portion includes the additional-component fixing hole.

Here, the bracket is fixed to the pillar main body. The additional-component fixing hole is formed in the bracket. This can facilitate fixing the additional component to the vehicle while reducing the influence of the orientation and the position of the pillar main body.

An eighth aspect is the vehicle according to any one of the third to seventh aspects, wherein the additional component includes: a base supported at a fixed position of the rear pillar; and a variable arm supported by the base variably between first and second positions.

Here, changing the position of the variable arm facilitates improving the convenience. For example, disposing the variable arm at the first position that is approximately horizontal facilitates supporting an object. The variable arm disposed at the second position hardly protrudes from the vehicle body.

A ninth aspect is the vehicle according to the eighth aspect, wherein the additional component further includes a retaining structure that is detachably inserted into the base and retains the variable arm selectively at the first and second positions.

Here, the retaining structure facilitates retaining the variable arm selectively at the first and second positions. The retaining structure may be implemented by, for example, pins.

A tenth aspect is the vehicle according to the eighth or ninth aspect, wherein the variable arm may be located outward of a center of the vehicle main body in a vehicle-width direction.

This prevents an interference with a load placed in the vicinity of the center in the vehicle-width direction and easily changes the arm from the first position to the second position.

An eleventh aspect is the vehicle according to any one of the eighth to tenth aspects, wherein the variable arm includes an arm main body supported by the base, and a branch arm protruding from the arm main body.

Since the branch arm protrudes from the arm main body, the variable arm can support many objects.

A twelfth aspect is the vehicle according to any one of the first to eleventh aspects, wherein the rear pillar may include a positioning portion that positions the additional component at a position corresponding to the mounting portion.

This can mount the additional component on the rear pillar with the additional component being positioned by the positioning portion, and simplify an operation of mounting the additional component.

A thirteenth aspect is the vehicle according to any one of the second to twelfth aspects, the vehicle further comprising a carrier disposed at a position lower than a position of the additional-component fixing hole, wherein the at least one additional component comprises a partition that can partition space above the carrier, and the additional component is fixed to the rear pillar with the partition being disposed along a rear extension of the carrier.

This disposes the partition that can partition the space above the carrier, along the rear extension of the carrier. Thus, the partition can be used not only as a partition on the carrier but also as a support base along the rear extension of the carrier.

A fourteenth aspect is the vehicle according to any one of the first to thirteenth aspects, wherein the at least one rear pillar comprises a right pillar and a left pillar, and the right pillar and the left pillar include respective mounting portions supported at a same height position, the respective mounting portions being included in the at least one mounting portion.

This facilitates mounting the additional component using the right and left mounting portions.

A fifteenth aspect is the vehicle according to any one of the first to fourteenth aspects, wherein the at least one mounting portion comprises an upper mounting portion, and a lower mounting portion lower than the upper mounting portion.

This can set an appropriate mounting position for each additional component, or mount the additional component using the upper and lower mounting portions.

A rack according to a sixteenth aspect is a rack mountable to a vehicle, the rack comprising: a base mountable to the vehicle; and a variable arm supported by the base variably between first and second positions.

In this rack, the variable arm can be changed between the first and second positions. Changing the position of the variable arm can dispose an object at a position at which the object is easily supported or the object hardly protrudes.

A seventeenth aspect is the rack according to the sixteenth aspect, the rack further comprising a middle frame extending along a vehicle-width direction.

This facilitates supporting a load placed in the vicinity of the center in the vehicle-width direction, using the middle frame.

A bracket according to an eighteenth aspect comprises: a vehicle fixing portion; an additional-component fixing portion; and a coupling portion supporting the vehicle fixing portion and the additional-component fixing portion with space, wherein the additional-component fixing portion includes an additional-component fixing hole for fixing an additional component.

In this bracket, the additional component can be fixed to the additional-component fixing portion using the additional-component fixing hole. Thus, the additional component can be easily fixed to the vehicle through the bracket. Since the vehicle fixing portion is spaced from the additional-component fixing portion, the additional component can be easily fixed using a clamp and the additional-component fixing hole.

A nineteenth aspect is the bracket according to the eighteenth aspect, wherein the additional-component fixing portion includes a positioning protrusion protruding opposite the vehicle fixing portion or a positioning recess.

This positions the additional component on a first plate using the positioning protrusion. Thus, the additional component is easily fixed to the bracket.

A twentieth aspect is the bracket according to the nineteenth aspect, wherein an end of the positioning protrusion is oriented in a direction away from the additional-component fixing hole.

Here, hooking the additional component on the positioning protrusion and bringing the additional component closer to the additional-component fixing hole facilitate positioning the additional component.

A twenty-first aspect is the bracket according to any one of the eighteenth to twentieth aspects, wherein the additional-component fixing portion extends larger than the vehicle fixing portion.

Thus, the additional component is stably mounted on the wider additional-component fixing portion, using the additional-component fixing portion.

A twenty-second aspect is the bracket according to any one of the eighteenth to twenty-first aspects, wherein the additional-component fixing portion is inclined with respect to the vehicle fixing portion.

This can set an inclination of the additional-component fixing portion differently from that of a surface to which the vehicle fixing portion is fixed.

The foregoing description is in all aspects illustrative and does not restrict this invention. Numerous modifications and variations that have not yet been exemplified are devised without departing from the scope of this invention.

What is claimed is:

1. A vehicle, comprising:
a vehicle main body;
a left rear pillar and a right rear pillar extending upward with respect to the vehicle main body, the left rear pillar and the right rear pillar each including a mounting portion; and
a cargo carrier detachably mounted to the mounting portion of the left rear pillar and the mounting portion of the right rear pillar.

2. The vehicle according to claim 1, wherein:
the mounting portion of the left rear pillar and the mounting portion of the right rear pillar each include a corresponding cargo carrier fixing hole penetrating in a direction crossing a longitudinal direction of a corresponding one of the rear pillars.

3. The vehicle according to claim 1, wherein:
the cargo carrier is fixed to the left rear pillar and the right rear pillar using the mounting portions.

4. The vehicle according to claim 1, wherein:
the mounting portions each face rearward of the vehicle main body.

5. The vehicle according to claim 1, wherein:
each of the rear pillars includes a corresponding pillar main body and a bracket,
each of the pillar main bodies is inclined rearward as progressing upward, and
each of the mounting portions includes a mounting surface located behind the corresponding pillar main body and in contact with the cargo carrier.

6. The vehicle according to claim 5, wherein:
each of the mounting surfaces extends along a vertical direction.

7. The vehicle according to claim 2, wherein:
each of the rear pillars includes a pillar main body and a bracket,
the brackets each includes:
a vehicle fixing portion fixed to each of the pillar main bodies;
a cargo carrier fixing portion to which the cargo carrier is fixed; and
a coupling portion coupling the vehicle fixing portion with the cargo carrier fixing portion such that the vehicle fixing portion and the cargo carrier fixing portion are spaced apart, and
the cargo carrier fixing portion includes the cargo carrier fixing hole.

8. The vehicle according to claim 3, wherein the cargo carrier includes:
a base supported at a fixed position of each of the rear pillars; and
a pair of movable arms supported by the base and movable between first and second positions.

9. The vehicle according to claim 8, wherein:
the cargo carrier further includes a retaining structure that is detachably within the base and retains the movable arm selectively at the first and second positions.

10. The vehicle according to claim 8, wherein:
the movable arm is located outward of a center of the vehicle main body in a vehicle-width direction.

11. The vehicle according to claim 8, wherein:
the movable arm includes an arm main body supported by the base, and a branch arm protruding from the arm main body.

12. The vehicle according to claim 1, wherein:
each of the rear pillars includes a corresponding positioning portion that positions the cargo carrier at a position corresponding to the mounting portion.

13. The vehicle according to claim 2, further comprising:
a carrier disposed at a position lower than a position of the cargo carrier fixing hole,
wherein:
the cargo carrier comprises a partition to partition space above the cargo carrier, and
the cargo carrier is fixed to the rear pillars with the partition being disposed along a rear extension of the cargo carrier.

14. The vehicle according to claim 1, wherein:
each of the mounting portions comprise a corresponding upper mounting portion, and a lower mounting portion which is lower than the corresponding upper mounting portion.

15. A rack mountable to a vehicle, the rack comprising:
a base mountable to the vehicle; and
a movable arm supported by the base which is movable between first and second positions.

16. The rack according to claim 15, wherein the base includes:
a middle frame extending along a vehicle-width direction.

17. A bracket, comprising:
a vehicle fixing portion;
an additional-component fixing portion; and
a coupling portion supporting the vehicle fixing portion and the additional-component fixing portion such that there is space between the vehicle fixing portion and the additional-component fixing portion,
wherein the additional-component fixing portion includes an additional-component fixing hole for fixing an additional component.

18. The bracket according to claim 17, wherein:
the additional-component fixing portion includes a positioning protrusion protruding opposite the vehicle fixing portion or a positioning recess, and
an end of the positioning protrusion is oriented in a direction away from the additional-component fixing hole.

19. The bracket according to claim 17, wherein:
the additional-component fixing portion extends larger than the vehicle fixing portion, and
the additional-component fixing portion is inclined with respect to the vehicle fixing portion.

20. The bracket according to claim 17, further comprising:
bolt receiving holes to mount the bracket to a pillar of a vehicle.
